(19) United States
(12) Patent Application Publication
(10) Pub. No.: US 2018/0035157 A1
(43) Pub. Date: Feb. 1, 2018

(54) LIQUID CRYSTAL TELEVISION DEVICE AND SYSTEM

(71) Applicant: Shenzhen China Star Optoelectronics Technology Co., Ltd., Shenzhen, Guangdong (CN)

(72) Inventors: Yin-hung CHEN, Shenzhen, Guangdong (CN); Yu-yeh CHEN, Shenzhen, Guangdong (CN); Yu WU, Shenzhen, Guangdong (CN)

(73) Assignee: Shenzhen China Star Optoelectronics Technology Co., Ltd., Shenzhen, Guangdong (CN)

(21) Appl. No.: 14/908,520

(22) PCT Filed: Dec. 25, 2015
(86) PCT No.: PCT/CN2015/098969

§ 371 Date: Jan. 28, 2016

(30) Foreign Application Priority Data
Dec. 2, 2015 (CN) 201510876110.9

(51) Int. Cl. H04N 21/422; G09G 3/36; G02F 1/1335; H04N 5/44

(52) U.S. Cl. CPC H04N 21/42221; H04N 5/44; G09G 3/36; G02F 1/133602

(57) ABSTRACT

The present disclosure recites a liquid crystal TV device and system. The liquid crystal TV device has an LCD body, a T-CON control circuit board and a signal conversion circuit board. The signal conversion circuit board is used to convert a video signal receiving from the content providing apparatus to a signal to be displayed for the LCD body, and to transmit the signal to be displayed to the T-CON control circuit board. The T-CON control circuit board drives the LCD body to display images according to the signal to be displayed. Further, the liquid crystal TV device does not have an SOC main control circuit board. With the aforementioned way, the present disclosure can lower the cost of the TV and is beneficial to simplify the internal structure of the TV device.

### FIELD OF THE INVENTION

The present invention relates to display technical field, especially to a liquid crystal television (TV) device and system

### BACKGROUND OF THE INVENTION

Liquid crystal TV have advantages of thin body, electricity-saving and power consumption, image steady, no irradiation and so on so that are favored by the users.

With reference to FIG. 1, a conventional liquid crystal TV 10 usually comprises a liquid crystal display (LCD) body 11, a timer control register (T-CON) control circuit board 12 and a System-On-a-Chip (SOC) main control circuit board 13 and so on. The SOC main control circuit board 13 is mainly used to receive the video signal from the cable digital TV set-top box and then to acquire the display signal for the LCD body by processing the video signal. The T-CON control circuit board 12 is used to drive the LCD body 11 to display according to the display signal transmitted from the SOC main control circuit board 13 so that the images are displayed.

Further, the SOC main control circuit board 13 has various kinds of connectors, besides for receiving the void signal from the digital TV set-top box and also for preforming various operation to the liquid crystal TV through a SOC chip own system and APP (a third party application, Application). Also, the SOC main control circuit board 13 can also receive the video signal transmitted from a smart set-top box 14 (such as Baidu box, Tmall box, Mi box) so that the TV can directly play the video of the smart set-top box. The smart set-top box 14 usually has a power connector to connect to the external power such as 220V household power to be supplied power by the external power.

Presently, the functions of the smart set-top box 14 are stronger and stronger. It not only has a great amount of videos but also can access internet wirelessly, can install various of APPs by itself and has the same function with the conventional digital TV set-top box to broadcast TV channels. Those functions are performed to play by transmitting to the SOC main control circuit board 13. However, when the SOC main control circuit board 13 connects to the smart set-top box 14, it only plays the role to convert the format of the signal and its own function is weakened and ignored. As a result, the most circuits on the SOC main control circuit board 13 are at idle status to cause the resources waste so that is harmful to lower the cost and the complexity of the circuit.

### SUMMARY OF THE INVENTION

The main technical problem to be solved by the present invention is to provide a liquid crystal TV device and system to lower the cost of the TV and to be beneficial to simplify the internal structure of the TV device.

To solve the aforementioned technical problems, the present invention uses one technical solution is to provide a liquid crystal TV device comprising an LCD body, a T-CON control circuit board and a signal conversion circuit board, wherein the signal conversion circuit board comprises a converting circuit, and a first connector and a second connector respectively connecting to the converting circuit; the first connector connects to the T-CON control circuit board; the second connector is adapted for connecting to an external content providing apparatus; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed; the liquid crystal TV device does not have a System-On-a-Chip (SOC) main control circuit board; the second connector of the signal conversion circuit board is an HDMI adapted for connecting a connector of the content providing apparatus; the T-CON control circuit board and the signal conversion circuit board are not formed on the same circuit board.

Further, it comprises a power circuit board, wherein the power circuit board comprises a power circuit and a transformer circuit; the power circuit connects to the transformer circuit; the transformer circuit respectively connects to the first connector and the second connector of the signal conversion circuit board to supply power to the T-CON control circuit board through the first connector and adapted to supply power to the content providing apparatus through the second connector; the transformer circuit also connects to a backlight driving circuit of the LCD body to supply a driving voltage to the backlight driving circuit; and wherein the second connector comprises a working voltage output lead adapted to output a desired working voltage to the content providing apparatus for working normally; a standby voltage output lead adapted to output a desired standby voltage to the content providing apparatus for standby; and an enable signal lead adapted to receive an enable signal sending from the content providing apparatus, transmitting the enable signal to the transformer circuit so that the transformer circuit provides driving voltage to the backlight driving circuit of the LCD body.

Further, the content providing apparatus is a smart set-top box; the working voltage output by the working voltage output lead is 12V or 24V; and the standby voltage output by the standby voltage output lead is 5V.

Further, it comprises at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

Further, at least one of the signal transmitting circuit boards and the T-CON control circuit board are assembled on the same circuit board.

To solve the aforementioned technical problems, the present invention uses another technical solution is to provide a liquid crystal TV device comprising an LCD body, a T-CON control circuit board and a signal conversion circuit board, wherein the signal conversion circuit board comprises a converting circuit, and a first connector and a second connector respectively connecting to the converting circuit; the first connector connects to the T-CON control circuit board; the second connector is adapted for connecting to an external content providing apparatus; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed; and the liquid crystal TV device does not have an SOC main control circuit board.

Further, the second connector of the signal conversion circuit board is an HDMI adapted for connecting a connector of the content providing apparatus.

Further, it comprises a power circuit board, wherein the power circuit board comprises a power circuit and a transformer circuit; the power circuit connects to the transformer circuit; the transformer circuit respectively connects to the first connector and the second connector of the signal conversion circuit board to supply power to the T-CON control circuit board through the first connector and adapted to supply power to the content providing apparatus through the second connector; the transformer circuit also connects to a backlight driving circuit of the LCD body to supply a driving voltage to the backlight driving circuit; and wherein the second connector comprises a working voltage output lead adapted to output a desired working voltage to the content providing apparatus for working normally; a standby voltage output lead adapted to output a desired standby voltage to the content providing apparatus for standby; and an enable signal lead adapted to receive an enable signal sending from the content providing apparatus, transmitting the enable signal to the transformer circuit so that the transformer circuit provides driving voltage to the backlight driving circuit of the LCD body.

Further, the content providing apparatus is a smart set-top box; the working voltage output by the working voltage output lead is 12V or 24V; and the standby voltage output by the standby voltage output lead is 5V.

Further, it comprises at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

Further, at least one of the signal transmitting circuit boards and the T-CON control circuit board are assembled on the same circuit board.

Further, the T-CON control circuit board and the signal conversion circuit board are not on the same circuit board.

To solve the aforementioned technical problems, the present invention uses still another technical solution is to provide a liquid crystal TV system comprising a content providing apparatus and a liquid crystal TV device, wherein the liquid crystal TV device comprises an LCD body, a T-CON control circuit board and a signal conversion circuit board; the signal conversion circuit board comprises a converting circuit, and a first connector and a second connector respectively connecting to the converting circuit; the first connector connects to the T-CON control circuit board; the second connector connects to the content providing apparatus mounted externally; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed; and the liquid crystal TV device does not have an SOC main control circuit board.

Further, the second connector of the signal conversion circuit board is an HDMI for connecting a connector of the content providing apparatus.

Further, it comprises a power circuit board, wherein the power circuit board comprises a power circuit and a transformer circuit; the power circuit connects to the transformer circuit; the transformer circuit respectively connects to the first connector and the second connector of the signal conversion circuit board to supply power to the T-CON control circuit board through the first connector and to supply power to the content providing apparatus through the second connector; the transformer circuit also connects to a backlight driving circuit of the LCD body to supply a driving voltage to the backlight driving circuit; and wherein the second connector comprises a working voltage output lead used to output a desired working voltage to the content providing apparatus for working normally; a standby voltage output lead used to output a desired standby voltage to the content providing apparatus for standby; and an enable signal lead used to receive an enable signal sending from the content providing apparatus, transmitting the enable signal to the transformer circuit so that the transformer circuit provides driving voltage to the backlight driving circuit of the LCD body.

Further, the content providing apparatus is a smart set-top box; the working voltage output by the working voltage output lead is 12V or 24V; and the standby voltage output by the standby voltage output lead is 5V.

Further, it comprises at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

Further, at least one of the signal transmitting circuit boards and the T-CON control circuit board are assembled on the same circuit board.

Further, the T-CON control circuit board and the signal conversion circuit board are not on the same circuit board.

The beneficial effect of the present invention is, comparing to the prior arts, in the liquid crystal TV device of the present invention, the liquid crystal TV device not having a SOC main control circuit board. By mounting a signal conversion circuit board to convert the video signal from the content providing apparatus to the desired signal to be displayed for the LCD body to allow the LCD body to display images. Thus, the SOC main control circuit is not needed to achieve the LCD body to display images so that the SOC main control circuit can be deleted to eliminate the low utilization module. Then the manufacturing cost is lower, the TV system is optimized, and the internal structure of the TV device is also simplified.

### BRIEF DESCRIPTION OF THE DRAWINGS

FIG. 1 is an illustrative view of the structure of a conventional liquid crystal TV;

FIG. 2 is an illustrative view of one embodiment of the structure of a liquid crystal TV device in accordance with the present invention;

FIG. 3 is an illustrative view of another embodiment of the structure of a liquid crystal TV device in accordance with the present invention; and

FIG. 4 is an illustrative view of one embodiment of the structure of a liquid crystal TV system in accordance with the present invention.

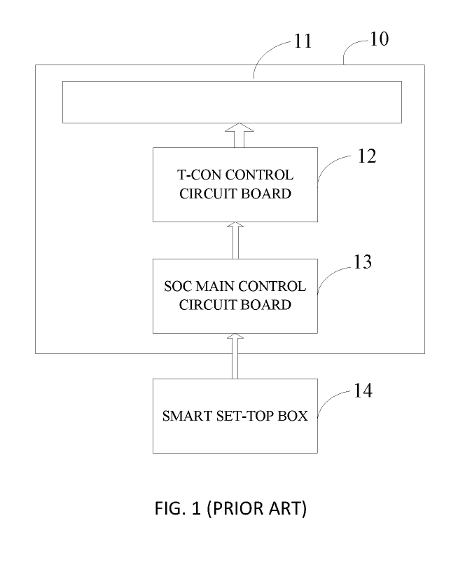

### DETAILED DESCRIPTION OF THE PREFERRED EMBODIMENTS

In conjunction with the accompanying drawings and the following embodiments of the present invention are described in detail.

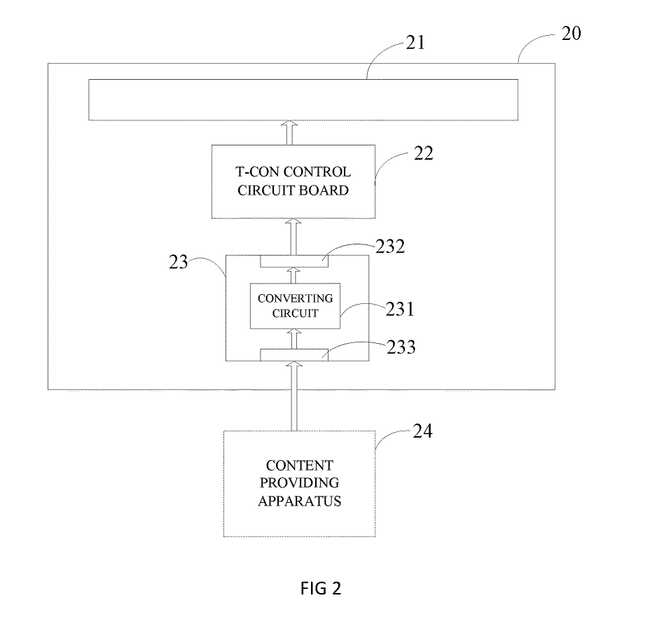

With reference to FIG. 2, in one embodiment of a liquid crystal TV device in accordance with the present invention, the liquid crystal TV device 20 may be a liquid crystal TV and does not have an SOC main control circuit board. The liquid crystal TV device 20 comprises an LCD body 21, a T-CON control circuit board 22 and a signal conversion circuit board 23.

Further, the signal conversion circuit board 23 comprises a converting circuit 231, and a first connector 232 and a second connector 233 respectively connecting to the converting circuit 231. The first connector 232 connects to the T-CON control circuit board 22. The second connector 233 is used to connect to an external content providing apparatus 24. Further, the content providing apparatus 24 is used to provide broadcast content for the liquid crystal TV device 24. The second connector 233 is used to receive the video signal from the content providing apparatus 24. The converting circuit 231 converts the video signal receiving from the second connector 233 to a signal to be displayed for the LCD body 21, and transmits the signal to be displayed to the T-CON control circuit board 22 through the first connector 232. Then the T-CON control circuit board 22 drives the LCD body 21 to display images according to the signal to be displayed so that driving the LCD body 21 to display is achieved.

In this embodiment, only a signal conversion circuit board 23 needs to be mounted in the liquid crystal TV device 20 to convert the video content from the content providing apparatus 24 to the display signal for the LCD body 21. Thus, there is no need to additionally mount an SOC main control circuit board and the broadcast function can still be achieved so that the SOC main control circuit board component can be eliminated from the liquid crystal TV device 20 to be beneficial to lower the cost. Besides, the converting circuit 231 is only used for convert signals. The complexity of its circuit is far less than the complexity of the SOC main control circuit board. Therefore, this embodiment optimizes the internal structure of the liquid crystal TV device 20 to simplify the wire structures and is beneficial to the development of the liquid crystal TV device to be light and thin.

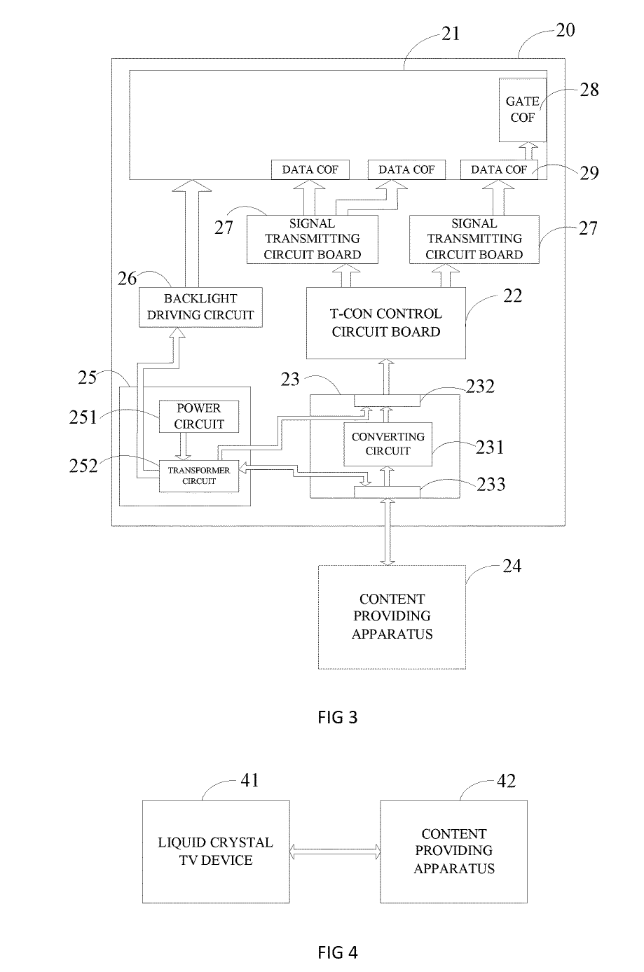

With reference to FIG. 3, FIG. 3 is an illustrative view of another embodiment of the structure of a liquid crystal TV device in accordance with the present invention, wherein the components with the same referenced number have the same function. In this embodiment, the content providing apparatus 24 may be a smart set-top box such as Baidu box, Tmall box, Mi box and may also be other content providing apparatus.

Further, the second connector 233 of the signal conversion circuit board 23 is an HDMI (High Definition Multimedia Interface) for connecting the connector of the content providing apparatus 24, i.e. the content providing apparatus 24 provides video contents to be HD (High Definition) video data.

As shown in FIG. 3, in this embodiment, the liquid crystal TV device 20 further comprises a power circuit board 25 and a backlight driving circuit 26. The back-light driving circuit 26 is a circuit in the backlight module to drive the backlight of the LCD body 21 to be illuminated. The power circuit board 25 comprises a power circuit 251 and a transformer circuit 252. The power circuit 251 is an AC/DC conversion circuit to connect the external power (such as 220V household AC power) for converting the voltage input by the external power such as converting alternating current into direct current, and outputs the converted voltage to the transformer circuit 252.

The transformer circuit 252 is used to transform the voltage input by the power circuit 252 to be desired working voltage for each module, such as the desired voltage of the T-CON control circuit board 22, the desired driving voltage of the backlight driving circuit. Further, the transformer circuit 252 respectively connects to the first connector 232 and the second connector 233 of the signal conversion circuit board 23. The transformer circuit 252 also connects to the backlight driving circuit 26.

Further, the power for the content providing apparatus 24 is supplied by the liquid crystal TV device 20 and shares the power circuit 251 with the liquid crystal TV device 20. Specifically, the transformer circuit 252 supplies power to the T-CON control circuit board 22 through the first connector 232 of the signal conversion circuit board 23, and supplies power to the content providing apparatus 24 through the second connector 233.

Further, the second connector 233 comprises a working voltage output lead, a standby voltage output lead and an enable signal lead. The transformer circuit 252 outputs the desired working voltage to the content providing apparatus 24 for working normally through the working voltage output lead, and outputs the desired standby voltage to the content providing apparatus 24 for standby through the standby voltage output lead. Thus, the power supplied to the content providing apparatus 24 is achieved. Further, the working voltage output by the working voltage output lead may be 12V or 24V, or any other output voltage. The standby voltage output by the standby voltage output lead may be 5V or any other standby voltage such as 3V or 2V. The output voltages by the working voltage output lead and the standby voltage output lead may be determined according to the model number of the content providing apparatus 24, and is not limited here.

Further, the transformer circuit 252 is also used to transform the voltage supplied by the power circuit 251 to the desired driving voltage for the backlight driving circuit 26 and outputs it to the backlight driving circuit 26. Thus, the backlight driving circuit 26 drives the backlight of the LCD body 21 to be illuminated so that the LCD body 21 can display the images.

In addition, the transformer circuit 252 receives the enable signal from the content providing apparatus 24 through the enable signal lead of the second connector 233. When the content providing apparatus 24 is turned on or is switched from the standby status to the working status, an enable signal is transmitted to the liquid crystal TV device 20 to notify the liquid crystal TV device 20 to be about to work. The transformer circuit 252 receives the enable signal and provides driving voltage to the backlight driving circuit 26 according to the enable signal so that the backlight driving circuit 26 drives the backlight to be illuminated.

Continually with reference to FIG. 3, the liquid crystal TV device 20 further comprises at least two signal transmitting circuit board 27. Further, the non-display area around the LCD body 21 bonds the gate driving circuit connecting to the scanning lines of the LCD body and the data driving circuit connecting to the data lines of the LCD body 21. Further, the gate driving circuit specifically is a gate driving IC. The data driving circuit specifically is a data driving IC. The gate driving IC and the data driving IC all use COF (Chip On Film) technic to proceed package. The COF is the technic that uses the flexible circuit board (FPC) as a package carrier to secure the IC on the FPC. As shown in FIG. 3, the FPC to secure the gate driving IC is a gate COF 28. The FPC to secure the data driving IC is a data COF 29. Since the amount of the IC is much more, the amount of the gate COF 28 and the data COF 29 are respectively also more than one. Each gate COF 28 has multiple gate driving IC packaged thereon. Each data COF 29 has multiple data driving IC packaged thereon. Further, the multiple gate COFs 28 are arranged sequentially along a short side of the LCD body 21. The multiple data COFs 29 are arranged sequentially along a longitudinal side of the LCD body 21.

The T-CON control circuit board 22 is mainly used to generate the desired control signals respectively for the gate driving ICs and the data driving ICs according to the signal to be displayed. The signal transmitting circuit board 27 has multiple transmitting wires to correspondingly transmit the control signals generated by the T-CON control circuit board 22 to the gate driving ICs on the gate COFs 28 and the data driving ICs on the data COFs 29. Further, in this embodiment, the multiple data COFs 29 directly connect to the corresponding signal transmitting circuit boards 27. One signal transmitting circuit board 27 may connect to the data driving ICs on one data COF 29, and may connect to the data driving ICs on the multiple data COFs 29. The multiple gate COFs 28 are not directly connected to the signal transmitting circuit boards 27, but receive the control signals from the T-CON control circuit board 22 through the data COFs 29 and the signal transmitting circuit boards 27 in sequence. Specifically, for the multiple data COFs 29 arranged in sequence, the signal transmitting circuit boards 27 connecting to the data COFs 29 at two ends, have one part of the transmitting wires connecting to the data driving ICs on the data COFs 29 to transmit the control signal from the T-CON control circuit board 22 to the data driving ICs, and have another part of the transmitting wires connect to the gate driving ICs on the gate COFs 28 through the empty areas on the data COFs 29 to transmit the control signal from the T-CON control circuit board 22 to the gate driving ICs. Then the data driving ICs and the gate driving ICs drive the LCD body 21 to display images according to the received control signals, i.e. the desired control signals of the gate driving ICs are transmitted sequentially through the signal transmitting circuit board 27 and the data COF 29 nearest to the gate COF 28 to the gate driving ICs. The desired control signals of the data driving ICs are directly transmitted from the signal transmitting circuit board 27.

Further, FIG. 3 only shows two signal transmitting circuit board 27, but more signal transmitting circuit board 27 may be mounted according to the size of the LCD body 21 to connect to the data COFs 29 and the T-CON control circuit board 22 while actual production.

In this embodiment, the LCD body 21 achieving to display images has following processes: When the liquid crystal TV device 20 is turned on, the power circuit board 25 respectively supplies power to the T-CON control circuit board 22, the content providing apparatus 24 and the transformer circuit 252. The video signal of the content providing apparatus 24 is transmitted to the converting circuit 231 through the second connector 233. The converting circuit 231 converts the video signal of the content providing apparatus 24, such as format conversion, to retrieve the signal to be displayed that is identifiable by the LCD body 21. The signal to be displayed is transmitted to the T-CON control circuit board 22 through the first connector 232. The T-CON control circuit board 22 respectively generates the desired control signals for the gate driving ICs and the data driving ICs according to the signal to be displayed, and the corresponding control signals are transmitted to the gate driving ICs and the data driving ICs through the signal transmitting circuit boards 27 to control the gate driving ICs to output the scanning signal to the LCD body 21 and to control the data driving ICs to output data signals to the LCD body 21. Then the LCD body 21 is driven to display images. More specifically, the desired control signals for the gate driving ICs generating by the T-CON control circuit board 22 are transmitted to the gate driving ICs one the gate COFs 28 sequentially through the signal transmitting circuit board 27 and the data COFs 29.

Therefore, by this embodiment, the liquid crystal TV device 20 does not have the SOC main control circuit board but achieves the images broadcasting through connecting the external content providing apparatus. Thus, the internal structure of the liquid crystal TV device 20 is optimized and the cost is reduced. In addition, the conventional content providing apparatus is usually supplied power by the external power (220V household power) so that needs to have corresponding power circuit mounted inside. In the present embodiment, the desired working voltage of the content providing apparatus 24 is directly supplied by the liquid crystal TV device 20. Comparing to the conventional way, the power module can be eliminated from the content providing apparatus 24 to be beneficial to simplify the structure of the content providing apparatus 24 and to lower the manufacturing cost of the content providing apparatus 24.

In the embodiment of the liquid crystal TV device in accordance with the present invention, one of the signal transmitting circuit board 27 and the T-CON control circuit board 22 are assembled on the same circuit board. Specifically, the circuit on the signal transmitting circuit board 27 and the circuit on the T-CON control circuit board 22 are assembled on the same circuit board. Comparing to the conventional way to form two parts of the circuits respectively on two circuit boards, the internal structure of the liquid crystal TV device 20 is further simplified to reduce the space occupied by the circuit boards and to be beneficial to the development of the liquid crystal TV device 20 to be lighter and thinner.

Certainly, in the condition that the technology level is practicable, the multiple signal transmitting circuit boards 27 may be assembled with the T-CON control circuit board 22 on the same circuit board.

Further, in the embodiment of the liquid crystal TV device in accordance with the present invention, the T-CON control circuit board 22 and the signal conversion circuit board 23 is not on the same circuit board. Certainly, the T-CON control circuit board 22 and the signal conversion circuit board 23 may be assembled on the same circuit board to reduce the space occupied by the circuit boards.

With reference to FIG. 4, in the embodiment of the liquid crystal TV device in accordance with the present invention, the liquid crystal TV system comprises a liquid crystal TV device and a content providing apparatus 42. The content providing apparatus 42 is used to provide the desired video broadcasting content to the liquid crystal TV device 41. The liquid crystal TV device 41 has the same structure with any one of the aforementioned embodiments of the liquid crystal TV device.

Above are embodiments of the present invention, which does not limit the scope of the present invention. Any equivalent structures or equivalent processes utilizing the specification and drawings of the present invention, or directly or indirectly apply to other related technical field should be covered by the protected scope of the invention.

What is claimed is:

1. A liquid crystal television (TV) device comprising: a liquid crystal display (LCD) body, a timer control register (T-CON) control circuit board and a signal conversion circuit board, wherein
the signal conversion circuit board comprises a converting circuit, and a first connector and a second connector respectively connecting to the converting circuit; the first connector connects to the T-CON control circuit board; the second connector is adapted for connecting to an external content providing apparatus; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed;
the liquid crystal TV device does not have a System-On-a-Chip (SOC) main control circuit board; and
the second connector of the signal conversion circuit board is a high definition multimedia interface (HDMI) adapted for connecting a connector of the content providing apparatus; the T-CON control circuit board and the signal conversion circuit board are not formed on the same circuit board.

2. The liquid crystal TV device according to claim 1 further comprising a power circuit board, wherein the power circuit board comprises a power circuit and a transformer circuit;
the power circuit connects to the transformer circuit; the transformer circuit respectively connects to the first connector and the second connector of the signal conversion circuit board to supply power to the T-CON control circuit board through the first connector and adapted to supply power to the content providing apparatus through the second connector; the transformer circuit also connects to a backlight driving circuit of the LCD body to supply a driving voltage to the backlight driving circuit; and
wherein the second connector comprises
a working voltage output lead adapted to output a desired working voltage to the content providing apparatus for working normally;
a standby voltage output lead adapted to output a desired standby voltage to the content providing apparatus for standby; and
an enable signal lead adapted to receive an enable signal sending from the content providing apparatus, transmitting the enable signal to the transformer circuit so that the transformer circuit provides driving voltage to the backlight driving circuit of the LCD body.

3. The TV device according to claim 2, wherein the content providing apparatus is a smart set-top box; the working voltage output by the working voltage output lead is 12V or 24V; and the standby voltage output by the standby voltage output lead is 5V.

4. The liquid crystal TV device according to claim 1 further comprising at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

5. The liquid crystal TV device according to claim 4, wherein at least one of the signal transmitting circuit boards and the T-CON control circuit board are assembled on the same circuit board.

6. A liquid crystal TV device comprising: an LCD body, a T-CON control circuit board and a signal conversion circuit board, wherein
the signal conversion circuit board comprises a converting circuit, and a first connector and a second connector respectively connecting to the converting circuit; the first connector connects to the T-CON control circuit board; the second connector is adapted for connecting to an external content providing apparatus; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed; and
the liquid crystal TV device does not have an SOC main control circuit board.

7. The liquid crystal TV device according to claim 6, wherein the second connector of the signal conversion circuit board is an HDMI adapted for connecting a connector of the content providing apparatus.

8. The liquid crystal TV device according to claim 7 further comprising a power circuit board, wherein the power circuit board comprises a power circuit and a transformer circuit;
the power circuit connects to the transformer circuit; the transformer circuit respectively connects to the first connector and the second connector of the signal conversion circuit board to supply power to the T-CON control circuit board through the first connector and adapted to supply power to the content providing apparatus through the second connector; the transformer circuit also connects to a backlight driving circuit of the LCD body to supply a driving voltage to the backlight driving circuit; and
wherein the second connector comprises
a working voltage output lead adapted to output a desired working voltage to the content providing apparatus for working normally;
a standby voltage output lead adapted to output a desired standby voltage to the content providing apparatus for standby; and
an enable signal lead adapted to receive an enable signal sending from the content providing apparatus, transmitting the enable signal to the transformer circuit so that the transformer circuit provides driving voltage to the backlight driving circuit of the LCD body.

9. The liquid crystal TV device according to claim 8, wherein the content providing apparatus is a smart set-top box; the working voltage output by the working voltage output lead is 12V or 24V; and the standby voltage output by the standby voltage output lead is 5V.

10. The liquid crystal TV device according to claim 6 further comprising at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

11. The liquid crystal TV device according to claim 10, wherein at least one of the signal transmitting circuit boards and the T-CON control circuit board are assembled on the same circuit board.

12. The liquid crystal TV device according to claim 6, wherein the T-CON control circuit board and the signal conversion circuit board are not on the same circuit board.

13. A liquid crystal TV system comprising a content providing apparatus and a liquid crystal TV device, wherein the liquid crystal TV device comprises an LCD body, a T-CON control circuit board and a signal conversion circuit board;
the signal conversion circuit board comprises a converting circuit, and a first connector and a second connector respectively connecting to the converting circuit; the first connector connects to the T-CON control circuit board; the second connector connects to the content providing apparatus mounted externally; the converting circuit converts a video signal receiving through the second connector from the content providing apparatus to a signal to be displayed for the LCD body, and transmits the signal to be displayed to the T-CON control circuit board through the first connector; the T-CON control circuit board drives the LCD body to display images according to the signal to be displayed; and
the liquid crystal TV device does not have an SOC main control circuit board.

14. The liquid crystal TV system according to claim 13, wherein the second connector of the signal conversion circuit board is an HDMI for connecting a connector of the content providing apparatus.

15. The liquid crystal TV system according to claim 14 further comprising a power circuit board, wherein the power circuit board comprises a power circuit and a transformer circuit;
the power circuit connects to the transformer circuit; the transformer circuit respectively connects to the first connector and the second connector of the signal conversion circuit board to supply power to the T-CON control circuit board through the first connector and to supply power to the content providing apparatus through the second connector; the transformer circuit also connects to a backlight driving circuit of the LCD body to supply a driving voltage to the backlight driving circuit; and
wherein the second connector comprises
a working voltage output lead used to output a desired working voltage to the content providing apparatus for working normally;
a standby voltage output lead used to output a desired standby voltage to the content providing apparatus for standby; and
an enable signal lead used to receive an enable signal sending from the content providing apparatus, transmitting the enable signal to the transformer circuit so that the transformer circuit provides driving voltage to the backlight driving circuit of the LCD body.

16. The liquid crystal TV system according to claim 15, wherein the content providing apparatus is a smart set-top box; the working voltage output by the working voltage output lead is 12V or 24V; and the standby voltage output by the standby voltage output lead is 5V.

17. The liquid crystal TV system according to claim 13 further comprising at least two signal transmitting circuit boards, wherein the T-CON control circuit board respectively connects to the at least two signal transmitting circuit boards; the T-CON control circuit board generates desired control signals respectively for gate driving circuits and data driving circuits according to the signal to be displayed and correspondingly transmits the control signals to the gate driving circuits and the data driving circuits on the LCD body through the signal transmitting circuit boards to control the gate driving circuits and the data driving circuits to drive the LCD body to display images.

18. The liquid crystal TV system according to claim 17, wherein at least one of the signal transmitting circuit boards and the T-CON control circuit board are assembled on the same circuit board.

19. The liquid crystal TV system according to claim 13, wherein the T-CON control circuit board and the signal conversion circuit board are not on the same circuit board.
